(19) United States
(12) Patent Application Publication
(10) Pub. No.: US 2006/0092192 A1
(43) Pub. Date: May 4, 2006

(54) Fume hood for printing equipment

(76) Inventor: Chau Vo, Roxboro (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/232,911

(22) Filed: Sep. 23, 2005

Related U.S. Application Data
(60) Provisional application No. 60/612,514, filed on Sep. 24, 2004.
(60) Provisional application No. 60/686,398, filed on Jun. 2, 2005.

(51) Int. Cl. B41J 3/00

(52) U.S. Cl. 347/2

(57) ABSTRACT

A fume hood apparatus in combination with a printer comprises a printer outputting printout sheets, a suction source and a support structure. A hood is supported by the support structure. The hood has a hollow cavity, and an inlet and an outlet in fluid communication with the hollow cavity. The outlet is in fluid communication with the suction source. The inlet has a peripheral configuration associated with the printer such that a suction volume is created between a peripheral surface of the hollow cavity and a fume-emitting surface of a printout sheet output by the printer, upon actuation of the suction source, whereby printing fumes from the printer are removed from the suction volume by the suction source.

### CROSS-REFERENCE TO RELATED APPLICATIONS

This patent application claims priority on U.S. Provisional Patent Applications No. 60/612,514, filed on Sep. 24, 2004, and No. 60/686,398, filed on Jun. 2, 2005, both by the present applicant.

### BACKGROUND OF THE INVENTION

1. Field of the Invention

The present invention relates to a fume hood for printing equipment and, more particularly but not exclusively, to a fume hood and method used with a large-format printer.

2. Background Art

Printing equipment has evolved in producing new printing equipment as a response to ever increasing and diversified demand in printing formats, resolution, finish, amongst various factors. As a function thereof, a wide variety of printers have been developed according to the various needs of the printing industry. Accordingly, large-format printers are readily available (e.g., ink jet format).

A disadvantage associated with larger printers (e.g., large-format printers) is that a non-negligible amount of fumes emanates from the printouts of such printers, because of the quantity of ink used to cover the large surfaces of such printouts. Such fumes are toxic above some levels of concentration. Therefore, printing equipment such as larger printers is often confined to a printing room with adequate ventilation, or with restricted access.

Moreover, the output rate of large-format printers is often limited by a drying period for the ink. Accordingly, some large-format printers are provided with heaters to accelerate the drying period of the ink, yet this results in increased emanations over time.

For instance, dryers have been developed to be used in combination with large-format printers. One known dryer, the IP-263 dryer (www.seiko-i.com), has a plurality of fans blowing heated air on the inked surface of the printout of a large-format printer. Although such a dryer increases the output rate of the large-format printer by accelerating the drying period, emanations are increased over time, and this typically leads to the confinement of the large-format printer to a dedicated printing room.

### SUMMARY OF INVENTION

It is therefore an aim of the present invention to provide a novel fume hood for printers.

It is a further aim of the present invention to provide a fume hood that addresses issues associated with the prior-art systems.

It is a further aim of the present invention to provide a method for disposing of fumes in a printing environment.

Therefore, in accordance with the present invention, there is provided a fume hood apparatus in combination with a printer, comprising: a printer outputting printout sheets; a suction source; a support structure; and a hood supported by the support structure, the hood having a hollow cavity, and an inlet and an outlet in fluid communication with the hollow cavity, the outlet being in fluid communication with the suction source, the inlet having a peripheral configuration associated with the printer such that a suction volume is created between a peripheral surface of the hollow cavity and a fume-emitting surface of a printout sheet output by the printer, upon actuation of the suction source; whereby printing fumes from the printer are removed from the suction volume by the suction source.

Further in accordance with the present invention, there is provided a method for collecting fumes emanating from a printer, comprising the steps of: providing a hood connected to a suction source; positioning the hood adjacent to a fume source of the printer so as to define a suction volume between the hood and a printout sheet of the printer; and activating the hood to collect fumes from the fume source of the printer through the suction volume.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a perspective view of a hood apparatus in accordance with a first embodiment of the present invention, in an operating configuration with a treatment station with respect to a printer;

FIG. 2 is a perspective view of the hood apparatus of FIG. 1, without a suction drum;

FIG. 3 is an enlarged view of a connector of the hood apparatus of FIG. 1, without the suction drum;

FIG. 4 is a perspective view of the hood apparatus of FIG. 1, in a first maintenance position;

FIG. 5 is a perspective view of the hood apparatus of FIG. 1, in a second maintenance position;

FIG. 6 is a perspective view of the hood apparatus in accordance with an alternative embodiment of the present invention, in an operating configuration with the treatment station with respect to the printer;

FIG. 7 is a perspective view of the hood apparatus in accordance with yet another embodiment of the present invention, in an operating configuration with respect to a printer;

FIG. 8 is an enlarged perspective view of the hood apparatus of FIG. 7, showing a suction enclosure;

FIG. 9 is a perspective view of the hood apparatus of FIG. 7, in an operating configuration with respect to a printer;

FIG. 10 is a perspective view of the hood apparatus of FIG. 7, separated from the printer to illustrate a heater;

FIG. 11 is an enlarged perspective view of the hood apparatus of FIG. 7, showing the heater and deflector; and

FIG. 12 is an enlarged perspective view of the hood apparatus of FIG. 7, showing the heater and deflector.

### DESCRIPTION OF THE PREFERRED EMBODIMENTS

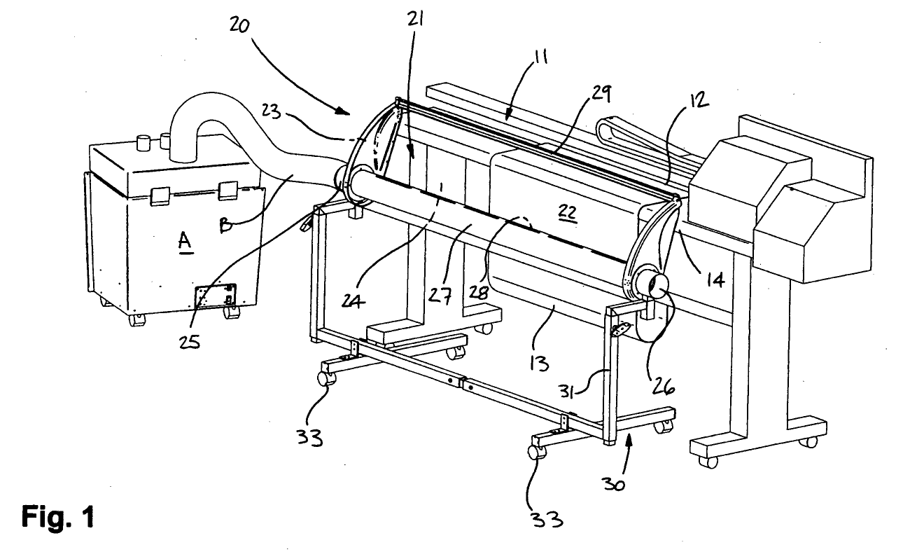

Referring now to the drawings and, more particularly, to FIG. 1, a hood apparatus in accordance with a preferred embodiment of the present invention is generally shown at 20, in an operating position with respect to a printer 10.

In FIG. 1, the printer 10 is a large-format printer having a printing section 11, by which a substrate (e.g., paper) from a substrate feed 12 is outputted as a printout 13. A heated drum 14 is positioned behind the printout 13, and is typically in contact therewith, to accelerate the drying of the ink of the printout 13.

The hood apparatus 20 is positioned adjacent to the printer 10. The hood apparatus 20 has a hood 21. Referring concurrently to FIGS. 1, 2 and 3, the hood 21 has a curved wall 22 and lateral walls 23, by which the hood 21 defines a concavity 24.

One of the lateral walls 23 has a connector 25, whereas the other of the lateral walls 23 has a support member 26. More precisely, the connector 25 is a hollow cylinder defining an opening in the respective lateral wall 23. A portion of the connector 25 extends beyond the lateral wall 23 and out of the hood 21. On the other hand, the support member 26 is a hollow cylinder that is closed.

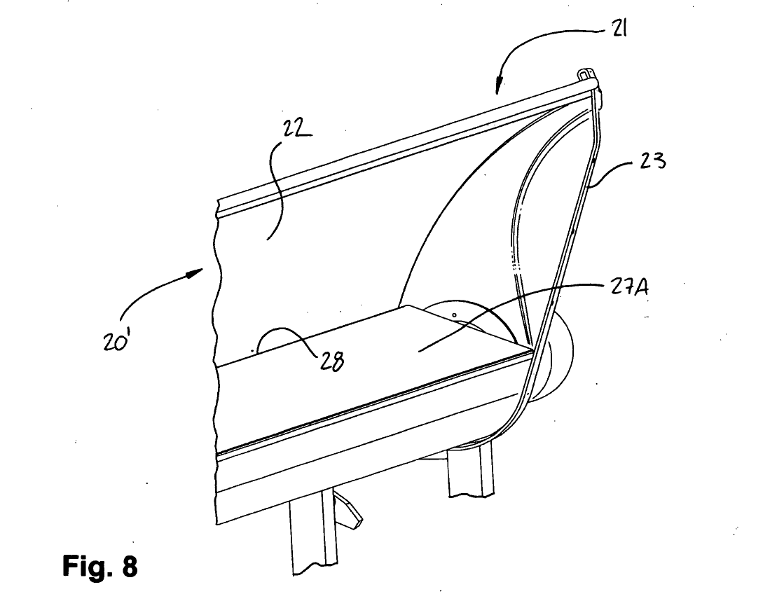

As seen in FIG. 1, the connector 25 and the support member 26 are shaped so as to support a suction enclosure 27 (e.g., a suction drum or like hollow compartment). The suction enclosure 27 has a hollow cylindrical body having a longitudinal slot 28 (or any other suitable slot pattern, e.g., ¾″ wide) on its periphery, through which slot 28 air enters the suction enclosure 27. The above-described slot configuration causes a generally even distribution of the airflow across the entire length of the hood 21 and increases the velocity of the flow. It is pointed out that other configurations are considered to define the longitudinal slot 28, such as a baffle plate 27A (FIG. 8) extending from one longitudinal edge of the curved wall 22 to an interior of the hood 21 to define the slot 28.

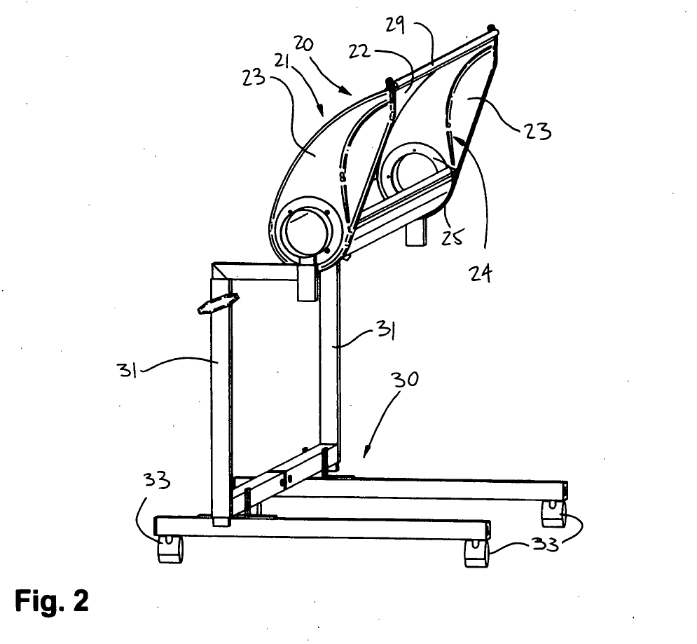

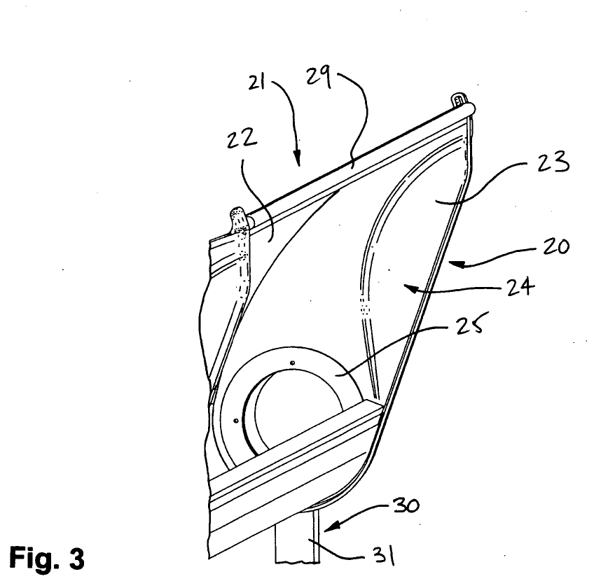

In FIGS. 2 and 3, the hood 21 is shown without the suction enclosure 27, whereby the opening in the connector 25 is visible. As will be described, a conduit (e.g., ventilation conduit, exhaust conduit) is to be connected to the protruding end of the connector 25, to convey air from the suction enclosure 27 out of the hood apparatus 20.

As shown in FIG. 1, a treatment station A is connected to the hood apparatus 20 by way of a flexible conduit B secured to the protruding end of the connector 25. The connection between the flexible conduit B and the connector 25 is preferably airtight to ensure an optimized flow of fluid from the suction enclosure 27 to the treatment station A. The treatment station A is any suitable station selected as a function of the printing fumes to be absorbed. For instance, the treatment station A may have various levels of filters, as well as active substances such as activated carbon that will react with the fumes of the printing operation.

Alternatively, the treatment station A may be replaced by a ventilation system (or like suction source) that will exhaust the printing fumes out of the printing environment for subsequent treatment, or exhaust.

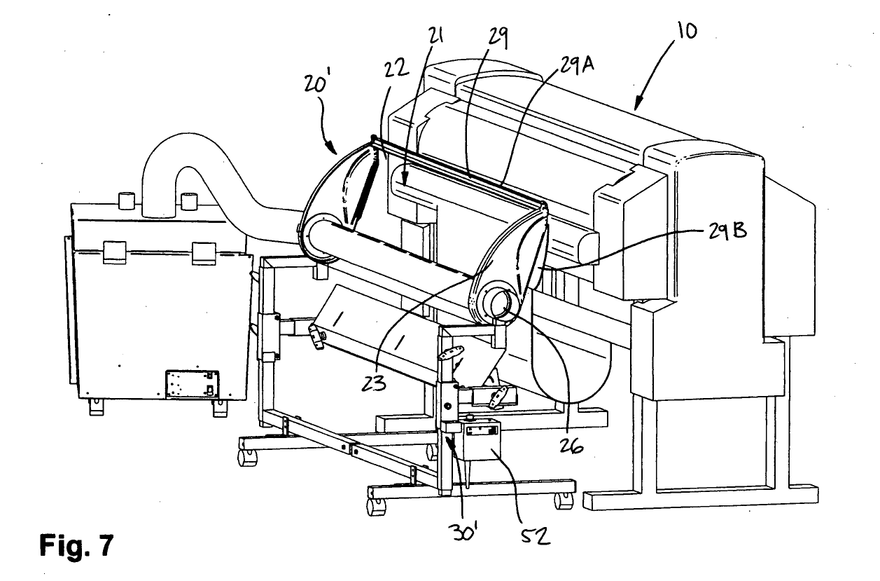

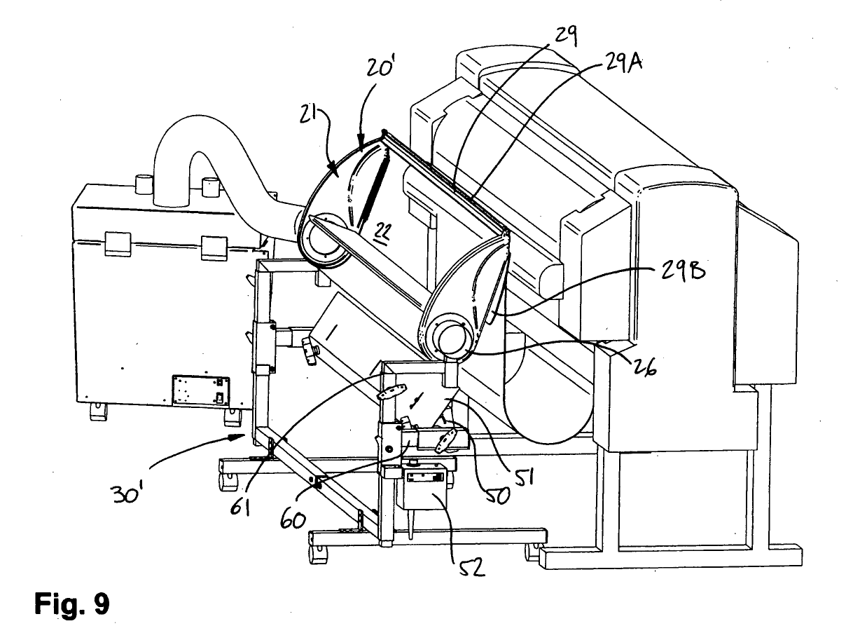

Referring to FIG. 1, the hood apparatus 20 is positioned such that the hood 21 is adjacent to the printer 10, with the concavity 24 being opposite the printout 13. Moreover, the concavity 24 and the heated drum 14 are on opposite sides of the printout 13. An edge 29 of the curved wall 22 is slightly separated from the printing section 11 of the printer 10. As shown at 29A, a sealing member is optionally provided on the edge 29 to seal off any gap between the casing of the printer 10 and the edge 29 of the hood 21. Moreover, as shown in FIGS. 7 and 9, sealing flaps 29B are optionally provided projecting from the lateral walls 23 to generally seal off any gap between the printer 10 and the lateral walls 23.

As the hood 21 covers the printout 13 after the printing section 11, the hood 21 will encapsulate the fumes emanating from the ink of the printout 13. The longitudinal slot 28 is oriented within the concavity 24 so as to generally cause a relative negative pressure within the concavity 24, to induce air from the concavity 24 into the suction enclosure 27. As the air within the concavity 24 has a high concentration of fumes (solvent fume-laden air), the fumes are collected/extracted by the suction enclosure 27 and exhausted through the conduit B, for instance to the treatment station A or other exhaust destination. It is pointed out that the hood apparatus 20 could be positioned elsewhere with respect to the printer 10, so as to collect fumes from any fume source associated with the printer 10.

The heated drum 14 of the printer 10 typically enhances fume emanation from the ink of the printout 13. As the concavity 24 is positioned generally across the heated drum 14 on the opposite side of the printout 13, the hood apparatus 20 increases its collection of fumes from the ink. The hood 21 also isolates the surrounding volume of the printout 13 from external air currents and drafts that would move the fumes out of the extraction air stream induced by the hood apparatus.

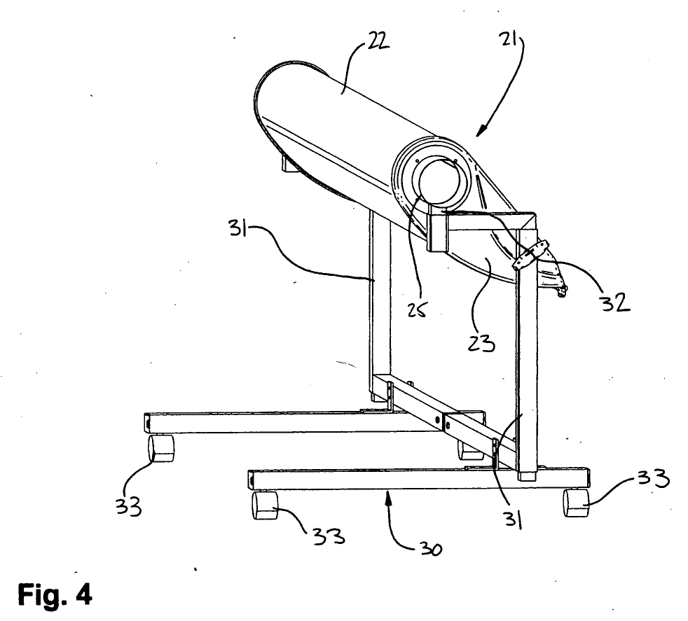

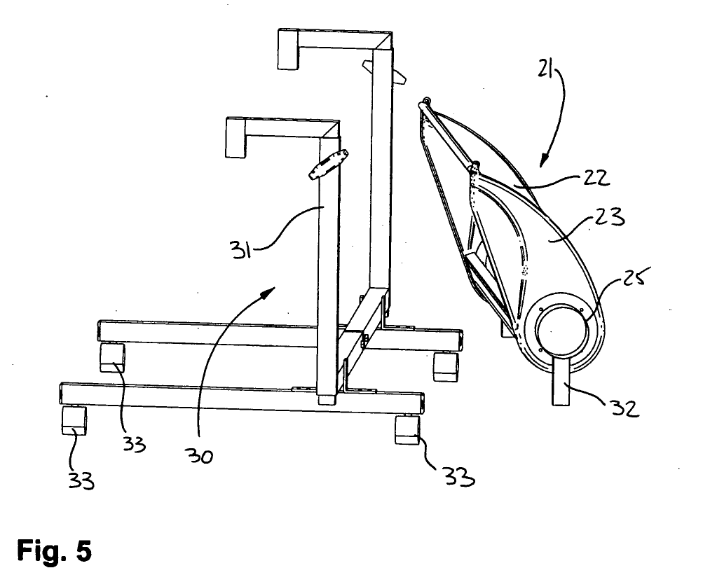

Referring concurrently to FIGS. 4 and 5, the hood 21 is shown being mounted to a structure 30. More specifically, the hood 21 is supported to legs 31 of the structure 30, by detachable connectors 32. The hood 21 is pivotable with respect to the detachable connectors 32, whereby the hood 21 may be pivoted away from its operating configuration (FIG. 1), to various maintenance positions, such as that illustrated in FIGS. 4 and 5, for instance to access the substrate.

The structure 30 is supported by casters 33, such that the hood apparatus 20 may be displaced toward or away from the printer 10. Accordingly, it is contemplated to retrofit printers with the hood apparatus 20 of the present invention. Moreover, the hood apparatus 20 may be retrofitted to existing exhaust systems. Although the connector 25 has a cylindrical end, other types of connector geometries may be used to enable various types of conduits to be compatible with the hood apparatus 21 of the present invention.

The combination of the slotted enclosure 27 and confining hood 21 allows the use of a low cfm extracting purifier as station A, which enables more solvent fumes to be captured with less air movement.

The curved wall 22 is shown made of a clear material, such as co-polyester. Co-polyester may have poor resistance to the solvent fume that is captured. For instance, co-polyester may soften when exposed to the solvent fume and be easily marred if touched. However, during the extraction process of the present invention, it was determined that the inside surface of the hood 21 would not be touched, so the hood material, if chosen as co-polyester, softens when exposed to the fumes but then returns to its original state after a period of time away from the fume. Co-polyester therefore represents a low-cost material with good optical clarity that can be used with the process of the present invention.

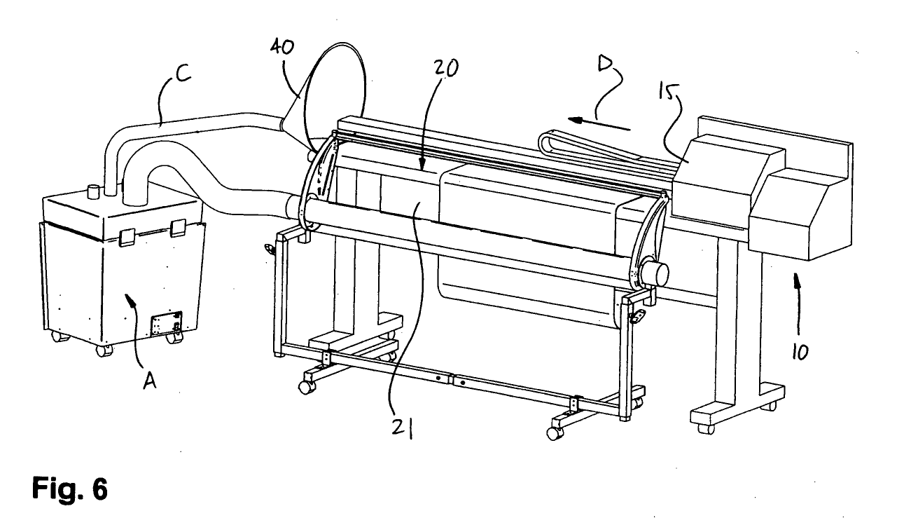

Referring to FIG. 6, in an alternative embodiment of the present invention, the hood apparatus 20 is shown having another hood 40. The hood 40 is in fluid communication with the treatment station A by way of a flexible conduit C. The hood 40 is funnel-shaped, and is secured to the printer 10. At this position, the hood 40 is generally opposite the printer head 15, when the latter is at the end of a printing stroke (direction D). It has been determined that the fume concentration at that position is relatively high for some printers, as the fumes of the ink may be entrained by the printer head 15. Accordingly, the hood 40 efficiently collects a portion of the fumes at that position.

It is pointed out that the hood 40 may be strategically positioned elsewhere with respect to the printer 10. For instance, if the printer head 15 is able to support the weight of the hood 40, the hood 40 could be mounted to the printer head 15.

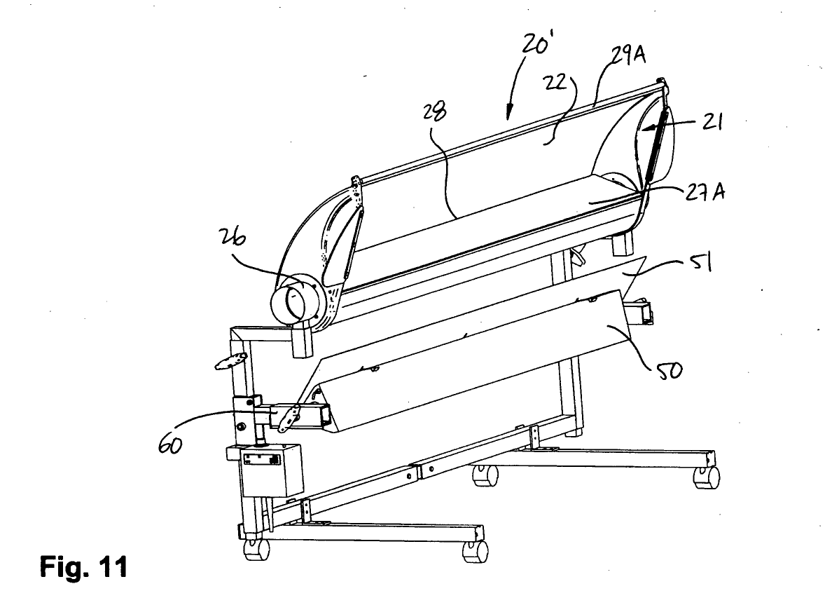

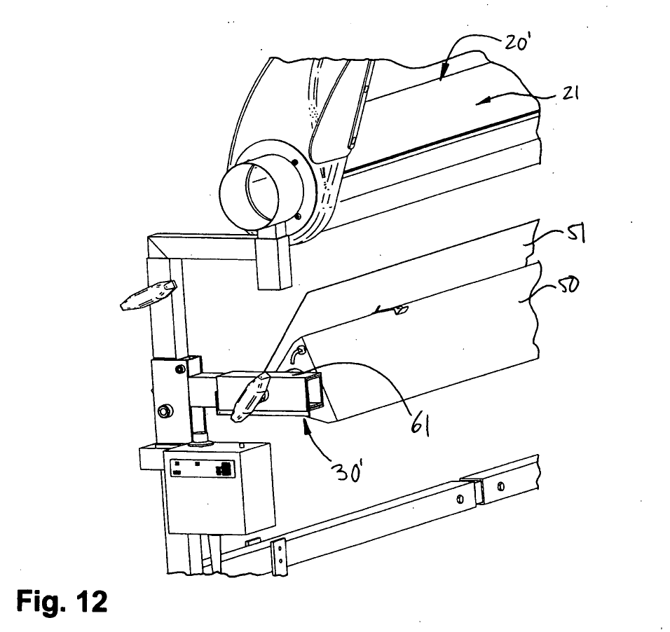

In order to accelerate the drying period of the ink, it is contemplated in an alternative embodiment to provide a heater with the hood apparatus 21. More specifically, referring to FIGS. 7 to 12, there is shown a hood apparatus 20′. The hood apparatus 20′ of FIGS. 7 to 12 and the hood apparatus 20 of FIGS. 1 to 6 have similar components, whereby like elements will bear like reference numerals.

The hood apparatus 20′, in addition to the hood 21 and associated components and to a structure 30′, has a heater 50. The heater 50 is provided so as to emit heat that will accelerate the drying period of the ink of the printout 13.

Referring to FIGS. 9 to 12, the heater 50 is preferably an infrared heater that is positioned below the hood 21, in proximity to the printout 13. The intensity of heat emitted by the heater 50 is controllable, for instance by way of a rheostat 52 (FIG. 7).

A deflector plate 51 is provided between the heater 50 and the hood 21, such that any suction exerted through the hood 21 results in a movement of air from the bottom up. Accordingly, solvent-laden air between the printout 13 and the heater 50 flows toward the slot 28 of the hood 21. Therefore, the deflector plate 51 increases the efficiency of the hood apparatus 20′.

In an embodiment, the deflector plate 51 is connected to the structure 30′ by way of magnets, such that the deflector plate 51 is readily releasable from the structure 30′.

It is considered to provide the hood apparatus 20′ with various types of printers. Therefore, a plurality of adjustment mechanisms are optionally provided so as to increase the efficiency of the hood apparatus 20′ in drying the ink of the printout 13, and in collecting fumes associated with the printout 13.

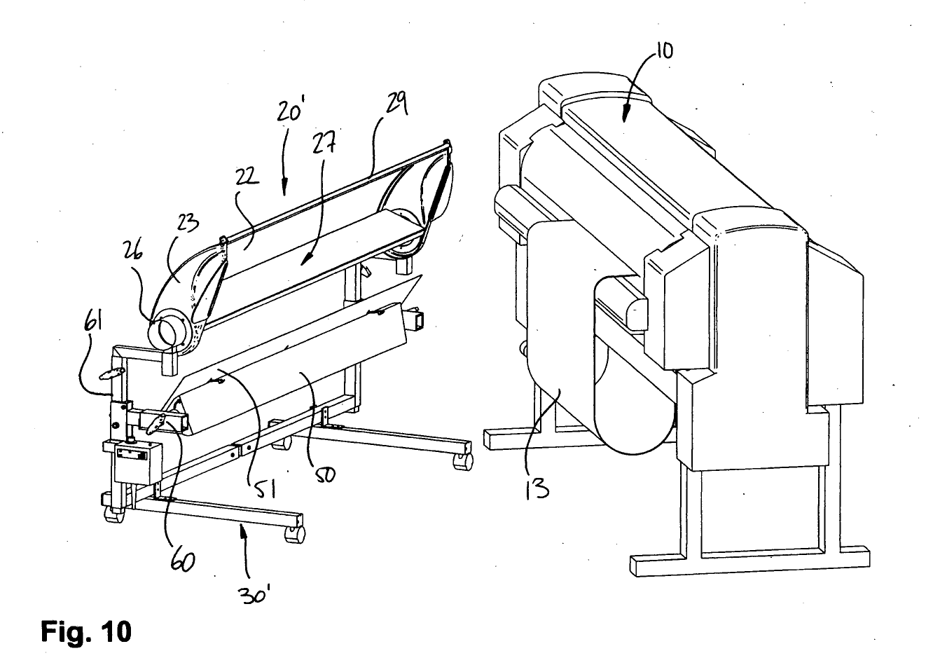

Referring to FIGS. 9 and 10, the structure 30′ has telescopic arms 60, so as to enable horizontal adjustment of the heater 50. The heater 50 is also pivotable at the end of the arms 60, whereby the heater 50 can be rotated to a suitable position with respect to the printout 13. Although the heater 50 is illustrated as being below the hood 21, it is contemplated to position the heater 50 in other positions as long as the hood 21 can collect the fumes generated by the heating of the ink by the heater 50.

The structure 30′ also has a telescopic portion 61, whereby the vertical spacing between the heater 50 and the hood 21 is adjustable. Finally, the structure 30′ can optionally be telescopic in a longitudinal direction, so as to adjust the structure 30′ to various sizes of hoods, such as the hood 21. For convenience, the hood apparatuses 20 and 20′ are typically actuated by way of local power outlets.

I claim:

1. A fume hood apparatus in combination with a printer, comprising:
a printer outputting printout sheets;
a suction source;
a support structure; and
a hood supported by the support structure, the hood having a hollow cavity, and an inlet and an outlet in fluid communication with the hollow cavity, the outlet being in fluid communication with the suction source, the inlet having a peripheral configuration associated with the printer such that a suction volume is created between a peripheral surface of the hollow cavity and a fume-emitting surface of a printout sheet output by the printer, upon actuation of the suction source;
whereby printing fumes from the printer are removed from the suction volume by the suction source.

2. The combination of claim 1, further comprising a heater supported by the support structure, the heater being positioned with respect to the hood so as to heat the printout sheet opposite the suction volume.

3. The combination of claim 2, wherein the heater is an infrared heater.

4. The combination of claim 2, wherein a rotational degree-of-freedom mechanism is provided between the heater and the support structure, so as to orient the heater with respect to the hood.

5. The combination of claim 2, wherein a translation degree-of-freedom mechanism is provided between the heater ad the support structure, so as to position the heater horizontally with respect to the hood.

6. The combination of claim 1, wherein the outlet has a hollow compartment extending longitudinally in the hollow cavity, and a slot in the hollow compartment parallel to a surface of the printout sheet for a generally uniform suction of the outlet along the printout sheet.

7. The combination of claim 1, further comprising a rotational degree-of-freedom mechanism between the hood and the support structure, so as to orient the hood with respect to the printer.

8. The combination of claim 7, wherein the rotational degree-of-freedom mechanism has a hollow cylinder about which the outlet of the hood is mounted for rotation, the hollow cylinder being connected to the suction source such that the outlet is in fluid communication with the suction source.

9. The combination of claim 1, further comprising lateral flaps peripherally positioned with respect to the inlet on the hood, so as to generally seal off a portion of the spacing between the hood and the printer.

10. The combination of claim 1, wherein the hood consists of a transparent material such that the printout sheet is visible through the hood.

11. The combination of claim 1, wherein the support structure has casters for being positioned with respect to the printer.

12. The combination of claim 1, wherein the suction source is a chemical treatment station absorbing fumes from air, so as to exhaust purified air in the vicinity of the printer.

13. The combination of claim 1, wherein the support structure has a translational-degree-of-freedom mechanism, so as to position vertically the hood with respect to the printer.

14. The combination of claim 1, wherein the suction volume is opposite a heater drum of the printer.

15. A method for collecting fumes emanating from a printer, comprising the steps of:
providing a hood connected to a suction source;
positioning the hood adjacent to a fume source of the printer so as to define a suction volume between the hood and a printout sheet of the printer; and
activating the hood to collect fumes from the fume source of the printer through the suction volume.

16. The method according to claim 15, wherein the fume source is the printout sheet of the printer, and further comprising a step of emitting heat toward the printout sheet to accelerate a drying period of the printout sheet.
